(19) United States
(12) Patent Application Publication
(10) Pub. No.: US 2014/0321367 A1
(43) Pub. Date: Oct. 30, 2014

(54) WIRELESS COMMUNICATION SYSTEM WITH MULTIPLE DEVICE-TO-DEVICE (D2D) COMMUNICATION CONFIGURATIONS

(71) Applicant: SPRINT COMMUNICATIONS COMPANY L.P., (US)

(72) Inventors: Sreekar Marupaduga, Overland Park, KS (US); Nicholas David Kullman, Kansas City, MO (US); Andrew Mark Wurtenberger, Olathe, KS (US)

(73) Assignee: SPRINT COMMUNICATIONS COMPANY L.P., Overland Park, KS (US)

(21) Appl. No.: 13/871,647

(22) Filed: Apr. 26, 2013

(51) Int. Cl. H04W 72/04

(52) U.S. Cl. CPC H04W 72/048
USPC 370/329

(57) ABSTRACT

A base station and user devices exchange signaling and responsively exchange user data over BS2D traffic links. The base station and user devices exchange more signaling and responsively exchange user data directly between user devices over D2D traffic links. The base station system selects one of a plurality of D2D configurations based on system conditions and transfers D2D configuration instructions to the user devices. Some of the D2D configurations have one user device as a hub device and the other user devices as non-hub devices. The base station and the user devices exchange more signaling and responsively transfer user data and signaling using the selected D2D configuration in response to the D2D configuration instructions.

### TECHNICAL BACKGROUND

Wireless communication devices and wireless base stations exchange control signaling and user data over wireless links. The wireless exchange of control signaling and user data occurs using various wireless protocols, such as Long Term Evolution (LTE), Code Division Multiple Access (CDMA), Global System for Mobile communications (GSM) networks. EVolution Data Optimized (EVDO), and High Speed Packet Access (HSPA). These wireless protocols include reverse signaling links that the wireless communication devices use to request service or to ACK/NACK data transfers. For example, LTE systems have a Physical Uplink Control Channel (PUCCH) for this purpose. These reverse signaling links may become overloaded.

LTE-Advanced includes the capability for wireless communication devices to engage in Device-to-Device (D2D) communications directly with one another instead of through the base station. Typically, the base station allocates traffic channels to the wireless communication devices for use in D2D communications, while the wireless devices maintain signaling links to the base station. These D2D communications may cause problems like inter-cell interference and intra-cell interference.

Unfortunately, present communication systems do not effectively and efficiently use D2D communications capabilities to mitigate network problems like overloaded signaling links and high intra-cell interference.

### TECHNICAL OVERVIEW

A base station and user devices exchange signaling and responsively exchange user data over BS2D traffic links. The base station and user devices exchange more signaling and responsively exchange user data directly between user devices over D2D traffic links. The base station system selects one of a plurality of D2D configurations based on system conditions and transfers D2D configuration instructions to the user devices. Some of the D2D configurations have one user device as a hub device and the other user devices as non-hub devices. The base station and the user devices exchange more signaling and responsively transfer user data and signaling using the selected D2D configuration in response to the D2D configuration instructions

### DESCRIPTION OF THE DRAWINGS

FIG. 1 illustrates a communication system to implement a plurality of Device-To-Device (D2D) configurations.

FIG. 2 illustrates a D2D configuration that may be selected and implemented by the communication system.

FIG. 3 illustrates a D2D configuration that may be selected and implemented by the communication system.

FIG. 4 illustrates a D2D configuration that may be selected and implemented by the communication system.

FIG. 5 illustrates a D2D configuration that may be selected and implemented by the communication system.

FIG. 6 illustrates a D2D configuration that may be selected and implemented by the communication system.

FIG. 7 illustrates a D2D configuration that may be selected and implemented by the communication system.

FIG. 8 illustrates the operation of a base station system to select and implement a plurality of Device-To-Device (D2D) configurations.

FIG. 9 illustrates a wireless communication device to implement a plurality of Device-To-Device (D2D) configurations.

FIG. 10 illustrates a base station system to select and implement a plurality of Device-To-Device (D2D) configurations.

### DETAILED DESCRIPTION

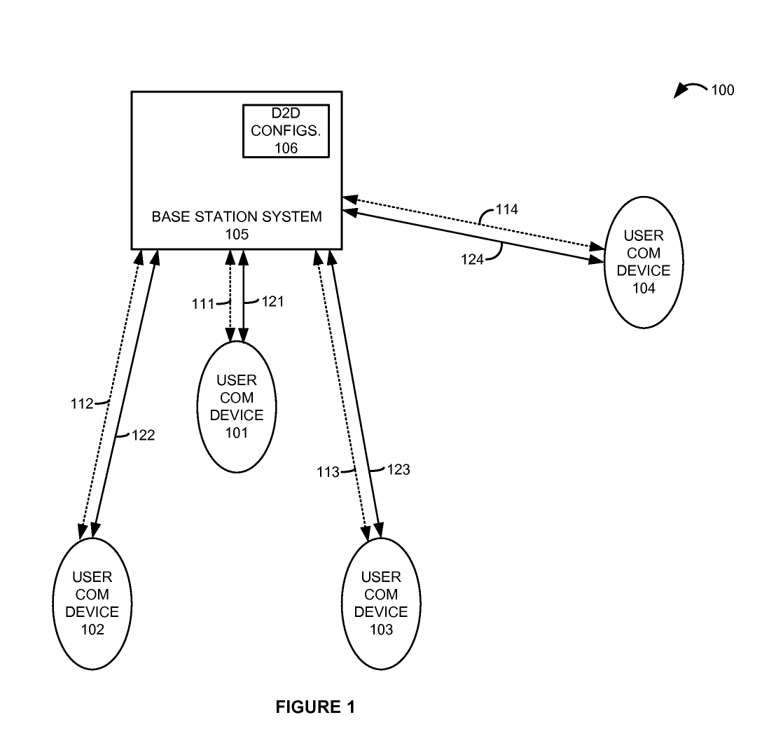

FIG. 1 illustrates communication system 100 to implement a plurality of Device-To-Device (D2D) configurations. Communication system 100 comprises user communication devices 101-104 and base station system 105. Base station system 105 stores a plurality of D2D configurations 106. Communication system 100 is typically more complex, but has been simplified to illustrate innovative aspects. Some conventional aspects of user communication devices 101-104 and base station system 105 are omitted for clarity, such as enclosures, power supplies, and the like.

User communication devices 101-104 and base station system 105 exchange wireless communications over signaling links 111-114 and traffic links 121-124. User communication devices 101-104 and base station system 105 comprise communication circuitry and software to support one or more wireless protocols, such as LTE, CDMA, GSM, EVDO, and HSPA. User communication devices 101-104 and base station system 105 typically also comprise communication circuitry and software to support one or more data protocols, such as IP, Ethernet, packet voice, and the like. Base station system 105 may have backhaul connectivity to one or more core networks over various wired and/or wireless data connections. User communication devices 101-104 might be phones, computers, media players, wireless transceivers, and/or some other apparatus with wireless networking components. User communication devices 101-104 may be integrated within other systems and devices, such as vehicles, appliances, apparel, and the like. User communication devices 101-104 detect and report various system conditions to base station system 105, such as inter-cell interference and failed access signaling.

Base station system 105 and user communication devices 101-104 wirelessly exchange control signaling over signaling links 111-114. The control signaling transfer over links 111-114 has forward components (from base station to user) and reverse components (from user to base station). Note that signaling links 111-114 are referred to as Base Station-To-Device (BS2D) links because they couple base station system 105 and user communication devices 101-104.

In response to the control signaling over signaling links 111-114, base station system 105 and user communication devices 101-104 wirelessly exchange user data over traffic links 121-124. The user data transfer over links 121-124 has forward components (from base station to user) and reverse components (from user to base station). Note that traffic links 121-124 are referred to as Base Station-To-Device (BS2D) links because they couple base station system 105 and user communication devices 101-104.

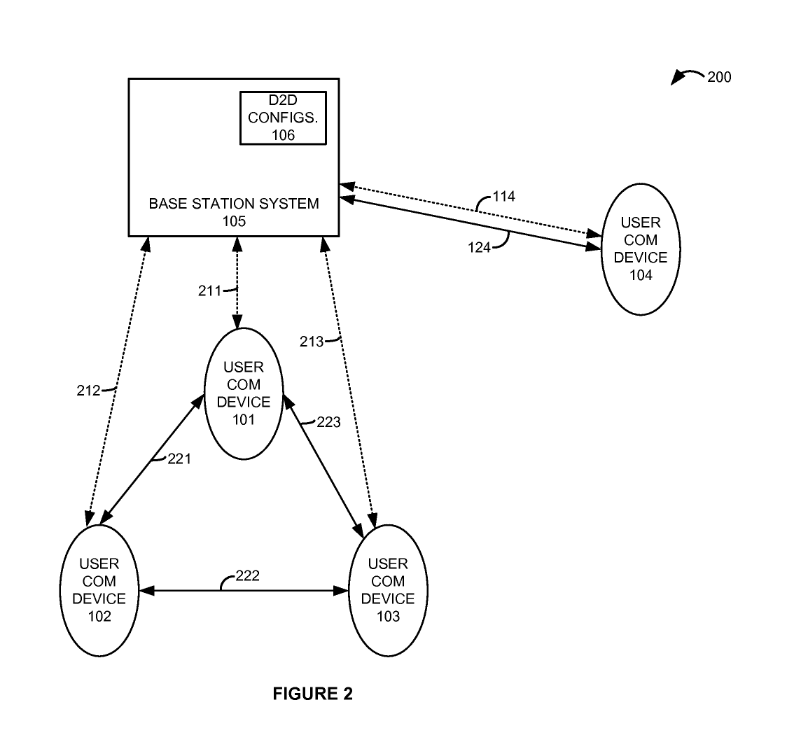

FIG. 2 illustrates D2D configuration 200 that may be selected and implemented by communication system 100. D2D configuration 200 may be used as a default D2D configuration in communication system 100. In D2D configuration 200, a D2D group comprising user communication devices 101-103 is formed (device 104 excluded from the group). The group may be selected based on proximity, user request, device capability, radio conditions, and/or other factors.

Base station system 105 and user communication devices 101-103 wirelessly exchange control signaling over BS2D signaling links 211-213. The control signaling on links 211-213 has forward and reverse components. In response to the control signaling over signaling links 211-213, user communication devices 101-103 wirelessly exchange user data over D2D traffic links 221-223. D2D links 221-223 comprise bi-directional wireless links between pairs of user devices. The user data transfer over D2D links 221-222 has forward and reverse components. Typically, base station system 105 signals the time/frequency parameters for D2D links 221-223 to user communication devices 101-103, although devices 101-103 may handle some of this task.

In some examples, D2D configuration 200 inhibits D2D communications to or from the D2D group of user devices 101-103. Thus, configuration 200 may inhibit D2D communications between user communication devices 101-103 and user communication device 104—possibly in response to system conditions. In some examples, base station system 105 identifies high interference (inter and/or intra cell), and in response, inhibits D2D communications between the group of devices 101-103 and other non-group devices like user communication device 104.

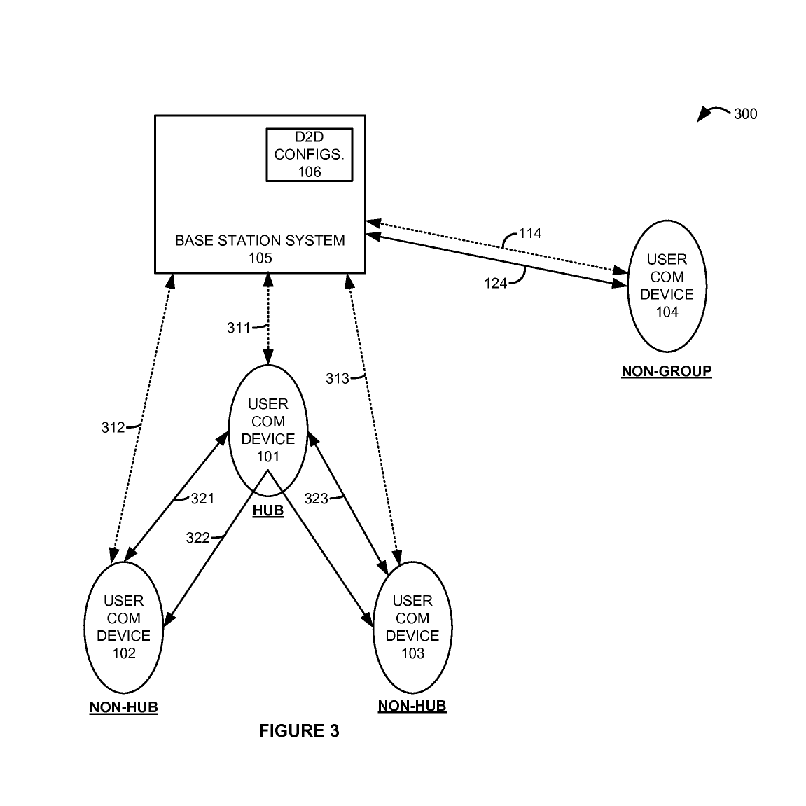

FIG. 3 illustrates D2D configuration 300 that may be selected and implemented by communication system 100. In some examples, base station system 105 selects and implements D2D configuration 300 in response to high inter and/or intra cell interference. In D2D configuration 300, a D2D group comprising user communication devices 101-103 is formed. The group may be selected based on proximity, user request, device capability, radio conditions, and/or other factors. Within the D2D group, user communication device 101 is designated as a hub device and user communication devices 102-103 are non-hub devices. A hub device exchanges wireless communications for non-hub devices.

Base station system 105 and user communication devices 101-103 wirelessly exchange control signaling over BS2D signaling links 311-313. The control signaling on links 311-313 has forward and reverse components. In response to the control signaling over signaling links 311-313, user communication devices 101-103 wirelessly exchange user data over D2D traffic links 321-323. Typically, base station system 105 signals the time/frequency parameters for D2D links 321-323 to user communication devices 101-103, although devices 101-103 may handle some of this task. The user data transfer over D2D links 321-323 has forward and reverse components. D2D links 321 and 323 comprise bi-directional wireless links between hub device 101 and non-hub devices 102-103. D2D link 322 comprises a bi-directional wireless link between non-hub devices 102-103 through hub device 101. D2D link 322 may use transport capacity in D2D links 321 and 323. In configuration 300, non-hub devices exchange user data with one another through the hub devices. Additional hub devices could be used in the group, but the number illustrated has been restricted for clarity.

In some examples, D2D configuration 300 inhibits D2D communications to or from hub user device 101 except with non-hub devices 102-103. Thus, configuration 200 may inhibit D2D communications between user communication devices 101 and 104 in response to various system conditions. In some examples, base station system 105 identifies high interference, and in response, inhibits D2D communications between hub devices from different D2D groups.

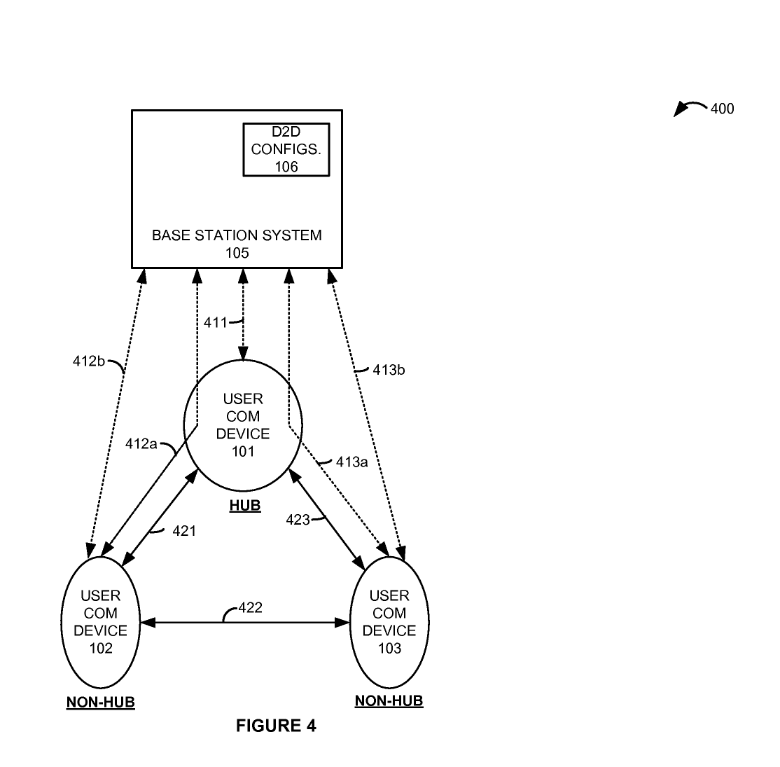

FIG. 4 illustrates D2D configuration 400 that may be selected and implemented by communication system 100. In some examples, base station system 105 selects and implements D2D configuration 400 in response to high amounts of control signaling—especially on reverse signaling links. In D2D configuration 400, a D2D group comprising user communication devices 101-103 is formed. The group may be selected based on proximity, user request, device capability, radio conditions, and/or other factors. Within the D2D group, user communication device 101 is designated as a hub device and user communication devices 102-103 are non-hub devices. A hub device exchanges wireless communications for non-hub devices. In configuration 400, non-hub devices 102-103 exchange at least some control signaling with base station system 105 through hub device 101. Additional hub devices could be used in the group, but the number illustrated has been restricted for clarity.

Base station system 105 and user communication devices 101-103 wirelessly exchange control signaling over signaling links 411-413. Note that signaling links 412a and 413a traverse hub communication device 101 in between base station system 105 and non-hub devices 102-103. Signaling links 412a and 413a may use transport capacity in D2D links 421-423. Signaling links 412a and 413a may also use transport capacity in signaling link 411. Typically, base station system 105 signals the time/frequency parameters for signaling links 412a and 413a to user communication devices 101-103, although devices 101-103 may handle some of this task. Forward and reverse signaling components may be distributed across signaling links 412-413 in various ways. In some examples, signaling links 412b and 412b are omitted. In some examples, signaling links 412a and 413a comprise Physical Uplink Control Channels (PUCCHs) in an LTE system.

In response to the control signaling over signaling links 411-413, user communication devices 101-103 wirelessly exchange user data over D2D traffic links 421-423. Typically, base station system 105 signals the time/frequency parameters for D2D links 421-423 to user communication devices 101-103, although devices 101-103 may handle some of this task. The user data transfer over D2D links 421-423 has forward and reverse components. D2D links 421-423 comprise bi-directional wireless links between user communication devices 101-103. In some examples, D2D links 421-423 provide transport for signaling links 412a and 413a.

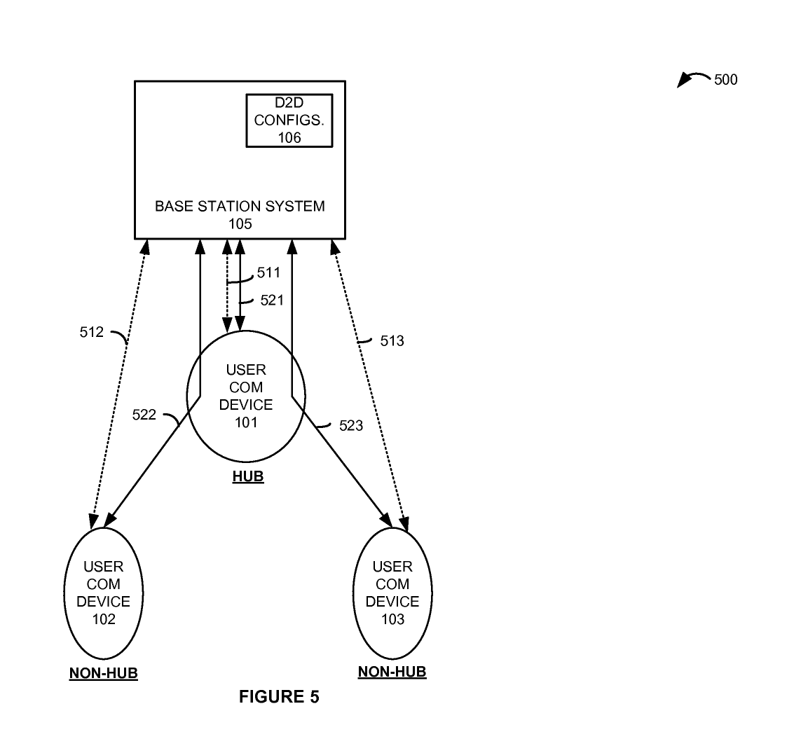

FIG. 5 illustrates D2D configuration 500 that may be selected and implemented by communication system 100. In some examples, base station system 105 selects and implements D2D configuration 500 in response to high amounts of user data traffic—especially on reverse traffic links. In D2D configuration 500, a D2D group comprising user communication devices 101-103 is formed. The group may be selected based on proximity, user request, device capability, radio conditions, and/or other factors. Within the D2D group, user communication device 101 is designated as a hub device and user communication devices 102-103 are non-hub devices. A hub device exchanges wireless communications for non-hub devices. In configuration 500, non-hub devices 102-103 exchange at least some user data with base station system 105 through hub device 101. Additional hub devices could be used in the group, but the number illustrated has been restricted for clarity.

Base station system 105 and user communication devices 101-103 wirelessly exchange control signaling over signaling links 511-513. In response to the control signaling over signaling links 511-513, user communication devices 101-103 wirelessly exchange user data over traffic links 521-523. D2D links between hub device 101 and non-hub devices 102-103 provide transport for traffic links 522-523. Traffic link 521 may provide transport for traffic links 522-523. Typically, base station system 105 signals the time/frequency parameters for the D2D links supporting links 522-523 to user communication devices 101-103, although devices 101-103 may handle some of this task. The user data transfer over traffic links 521-523 has forward and reverse components.

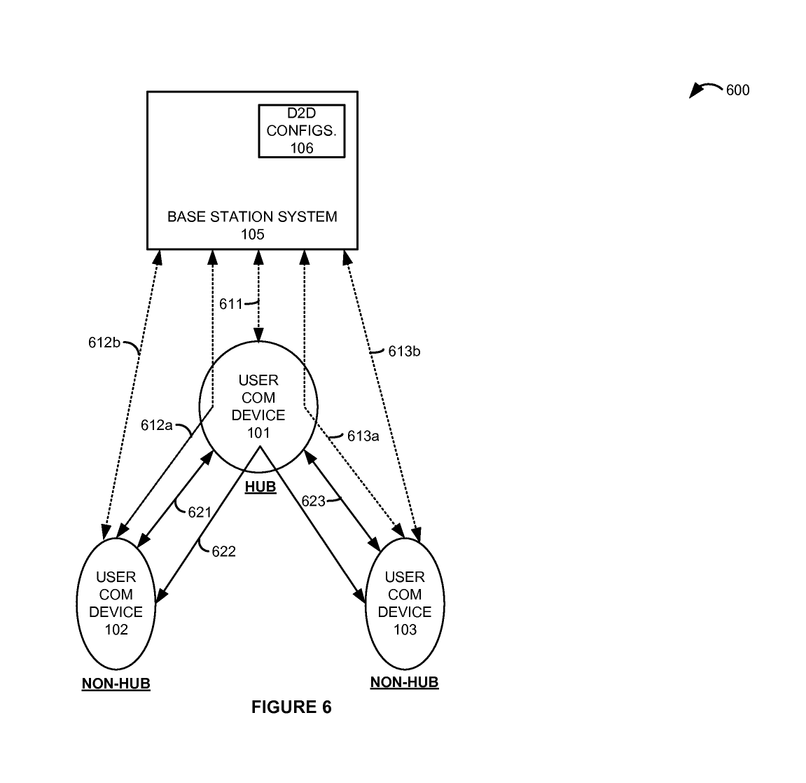

FIG. 6 illustrates D2D configuration 600 that may be selected and implemented by communication system 100. In some examples, base station system 105 selects and implements D2D configuration 600 in response to high amounts of control signaling and/or high amounts of cell interference. In D2D configuration 600, a D2D group comprising user communication devices 101-103 is formed. The group may be selected based on proximity, user request, device capability, radio conditions, and/or other factors. Within the D2D group, user communication device 101 is designated as a hub device and user communication devices 102-103 are non-hub devices. A hub device exchanges wireless communications for non-hub devices. In configuration 600, non-hub devices 102-103 exchange at least some control signaling with base station system 105 through hub device 101. In addition, non-hub devices 102-103 exchange user data with one another through hub device 101. Additional hub devices could be used in the group, but the number illustrated has been restricted for clarity.

Base station system 105 and user communication devices 101-103 wirelessly exchange control signaling over signaling links 611-613. Note that signaling links 612a and 613a traverse hub communication device 101 in between base station system 105 and non-hub devices 102-103. Signaling links 612a and 613a may use transport capacity in D2D links 621 and 623. Signaling links 612a and 613a may also use transport capacity in signaling link 611. Typically, base station system 105 signals the time/frequency parameters for signaling links 612a and 613a to user communication devices 101-103, although devices 101-103 may handle some of this task. Forward and reverse signaling components may be distributed across signaling links 612-613 in various ways. In some examples, signaling links 612b and 613b are omitted. In some examples, signaling links 612a and 613a comprise Physical Uplink Control Channels (PUCCHs) in an LTE system.

In response to the control signaling over signaling links 611-613, user communication devices 101-103 wirelessly exchange user data over D2D traffic links 621-623. Typically, base station system 105 signals the time/frequency parameters for D2D links 621-623 to user communication devices 101-103, although devices 101-103 may handle some of this task. The user data transfer over D2D links 621-623 has forward and reverse components. D2D links 621 and 623 comprise bi-directional wireless links between hub device 101 and non-hub devices 102-103. D2D link 622 comprises a bi-directional wireless link between non-hub devices 102-103 through hub device 101. D2D link 622 may use transport capacity in D2D links 621 and 623. In configuration 600, non-hub devices exchange user data with one another through the hub devices. Additional hub devices could be used in the group, but the number illustrated has been restricted for clarity.

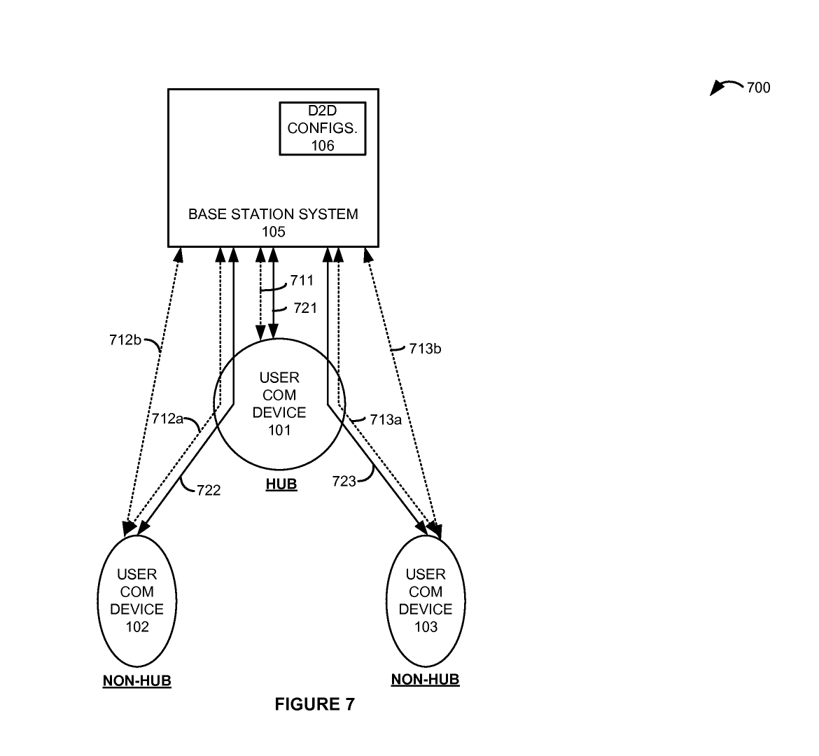

FIG. 7 illustrates D2D configuration 700 that may be selected and implemented by communication system 100. In some examples, base station system 105 selects and implements D2D configuration 700 in response to high amounts of control signaling and/or cell interference. In D2D configuration 700, a D2D group comprising user communication devices 101-103 is formed. The group may be selected based on proximity, user request, device capability, radio conditions, and/or other factors. Within the D2D group, user communication device 101 is designated as a hub device and user communication devices 102-103 are non-hub devices. A hub device exchanges wireless communications for non-hub devices. In configuration 700, non-hub devices 102-103 exchange at least some control signaling and user data with base station system 105 through hub device 101. Additional hub devices could be used in the group, but the number illustrated has been restricted for clarity.

Base station system 105 and user communication devices 101-103 wirelessly exchange control signaling over signaling links 711-713. Note that signaling links 712a and 713a traverse hub communication device 101 in between base station system 105 and non-hub devices 102-103. Signaling links 712a and 713a may use transport capacity in D2D links between device 101 and devices 102-103. Signaling links 712a and 713a may also use transport capacity in signaling link 711. Typically, base station system 105 signals the time/frequency parameters for the D2D links supporting signaling links 712a and 713a to user communication devices 101-103, although devices 101-103 may handle some of this task. Forward and reverse signaling components may be distributed across signaling links 712-713 in various ways. In some examples, signaling links 712b and 713b are omitted. In some examples, signaling links 712a and 713a comprise Physical Uplink Control Channels (PUCCHs) in an LTE system.

Base station system 105 and user communication devices 101-103 wirelessly exchange control signaling over signaling links 711-713. In response to the control signaling over signaling links 711-713, user communication devices 101-103 wirelessly exchange user data over traffic links 721-723. D2D links between hub device 101 and non-hub devices 102-103 provide transport for traffic links 722-723. Traffic link 721 may provide transport for traffic links 722-723. Typically, base station system 105 signals the time/frequency parameters for the D2D links supporting links 722-723 to user communication devices 101-103, although devices 101-103 may handle some of this task. The user data transfer over traffic links 721-723 has forward and reverse components.

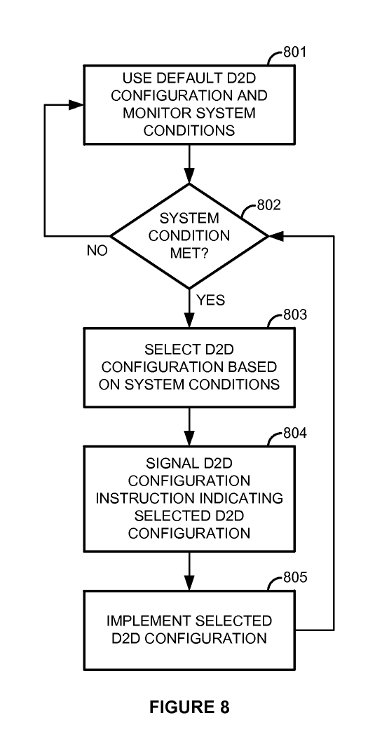

FIG. 8 illustrates the operation of base station system 105 to select and implement a plurality of Device-To-Device (D2D) configurations. The operation begins with the communication system 100 using a default D2D configuration (801), such as D2D configuration 200. Base station system 105 then monitors systems conditions, such as inter-cell interference, intra-cell interference, control signaling usage, and user data transfers (801). Wireless communication devices 101-104 may detect and report some of this data to base station system 105, such as detected inter-cell interference. If one or more of the system conditions exceeds a system threshold (802), then base station system 105 selects a D2D configuration based on system conditions (803). Note that timers and other metrics may be used at this point to prevent hysteresis between configurations.

For example, base station system 105 may aggregate reverse signaling using configuration 400, 600, or 700 in response to the amount of access requests or data ACKs exceeding a threshold. In another example, base station system 105 may compress D2D usage using configuration 300 or 600 in response to the amount of inter-cell or intra-cell interference exceeding a threshold.

Base station system 105 signals the selected D2D configuration to the user devices (804). These signals indicate timing and frequency information for the various communications in forward and reverse directions. Communication system 100 implements the selected D2D configuration in response to the signals (805). For example, base station system 105 might signal user devices 101-103 to change from configuration 200 to configuration 400 at a given time.

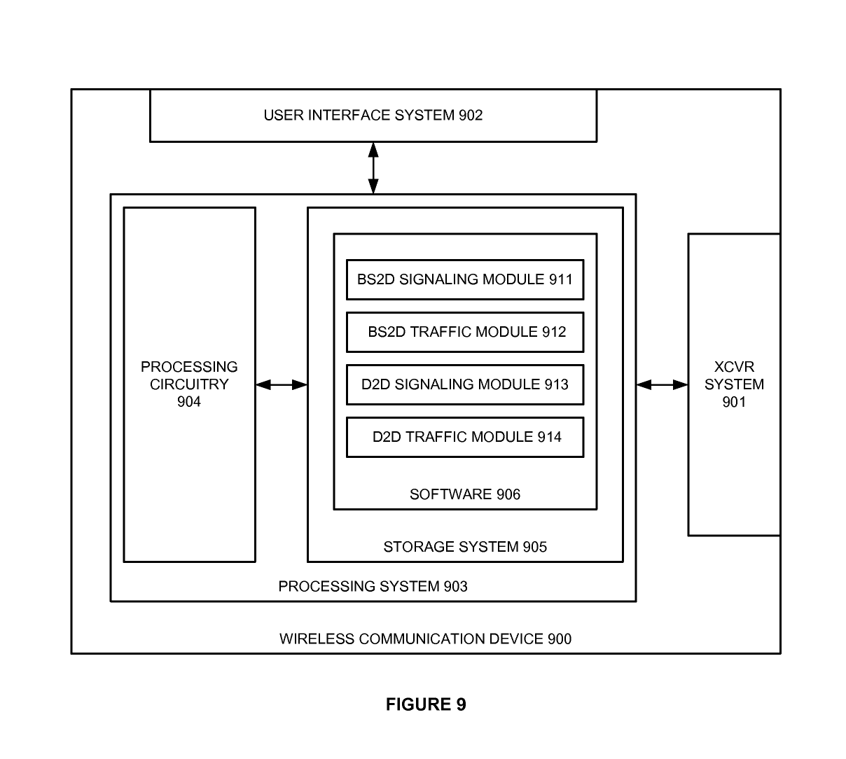

FIG. 9 illustrates wireless communication device 900 to implement a plurality of Device-To-Device (D2D) configurations. Wireless communication device 900 is an example of the communication devices described herein, although these devices may use alternative configurations. Wireless communication device 900 comprises transceiver system 901, user interface system 902, and processing system 903. Processing system 903 comprises processing circuitry 904 and storage system 905. Storage system 905 stores software 906. Wireless communication device 900 may be integrated within other systems and may be distributed across multiple diverse computer and communication systems. Some conventional aspects of wireless communication device 900 are omitted for clarity, such as power supplies, enclosures, and the like.

Transceiver system 901 comprises communication components, such as antennas, ports, filters, amplifiers, circuitry, memory, software, and the like. Transceiver system 901 uses protocols such as LTE, CDMA, GSM, EVDO, HSPA, WIFI, Bluetooth, IP, Ethernet, DOCSIS, or some other communication format. Transceiver system 901 establishes BS2D links and D2D links. Transceiver system 901 may integrate traffic and signaling links into these BS2D links and D2D links as described herein.

User interface system 902 comprises displays, touchscreens, speakers, microphones, vibrators, switches, buttons, lights, and/or some other human-to-machine interfaces.

Processing circuitry 904 comprises circuit boards that hold integrated circuitry and associated electronics. Storage system 905 comprises non-transitory, machine-readable, data storage media, such as flash drives, disc drives, and the like. Software 906 comprises machine-readable instructions that control the operation of processing circuitry 904 when executed. Software 906 includes modules 911-914 and may also include operating systems, applications, utilities, databases, and the like. All or portions of software 906 may be externally stored on flash drives, discs, servers, and the like.

When executed by processing circuitry 904, BS2D signaling module 911 directs circuitry 904 to exchange signaling over BS2D links as described herein—including the integration of multiple links. When executed by processing circuitry 904, BS2D traffic module 912 directs circuitry 904 to exchange user data over BS2D links as described herein—including the integration of multiple links. When executed by processing circuitry 904, D2D signaling module 913 directs circuitry 904 to exchange signaling over D2D links as described herein—including the integration of multiple links. When executed by processing circuitry 904, D2D traffic module 914 directs circuitry 904 to exchange user data over D2D links as described herein—including the integration of multiple links.

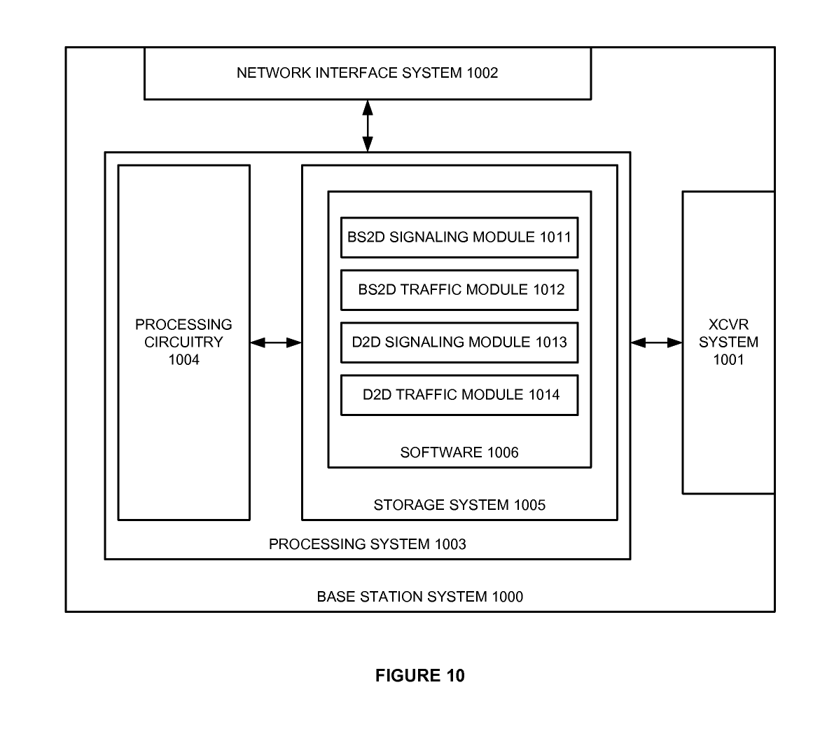

FIG. 10 illustrates base station system 1000 to implement a plurality of Device-To-Device (D2D) configurations. Base station system 1000 is an example of the base station system 105, although system 105 may use alternative configurations. Base station system 1000 comprises transceiver system 1001, network interface system 1002, and processing system 1003. Processing system 1003 comprises processing circuitry 1004 and storage system 1005. Storage system 1005 stores software 1006. Base station system 1000 may be integrated within other systems and may be distributed across multiple diverse computer and communication systems. Some conventional aspects of base station system 1000 are omitted for clarity, such as power supplies, towers, and the like.

Transceiver system 1001 comprises communication components, such as antennas, ports, filters, amplifiers, circuitry, memory, software, and the like. Transceiver system 1001 uses protocols such as LTE, CDMA, GSM, EVDO, HSPA, WIFI, Bluetooth, IP, Ethernet, DOCSIS, or some other communication format. Transceiver system 1001 establishes BS2D traffic and signaling links and D2D links. Transceiver system 1001 may integrate traffic and signaling links into these BS2D links as described herein.

Network interface system 1002 comprises backhaul communication components, such ports, routers, circuitry, memory, software, and the like. Network interface system 1002 uses protocols such as LTE, CDMA, GSM, EVDO, HSPA, IP, Ethernet, DOCSIS, or some other communication format. Network interface system 1002 exchanges user data and control signaling with one or more core networks.

Processing circuitry 1004 comprises circuit boards that hold integrated circuitry and associated electronics. Storage system 1005 comprises non-transitory, machine-readable, data storage media, such as flash drives, disc drives, and the like. Software 1006 comprises machine-readable instructions that control the operation of processing circuitry 1004 when executed. Software 1006 includes modules 1011-1014 and may also include operating systems, applications, utilities, databases, and the like. All or portions of software 1006 may be externally stored on flash drives, discs, servers, and the like.

When executed by processing circuitry 1004, BS2D signaling module 1011 directs circuitry 1004 to exchange control signaling over BS2D links as described herein—including the integration of multiple links. When executed by processing circuitry 1004, BS2D traffic module 1012 directs circuitry 1004 to exchange user data over BS2D links as described herein—including the integration of multiple links. When executed by processing circuitry 1004, D2D signaling module 1013 directs circuitry 1004 to select and implement configurations that exchange signaling over D2D links as described herein—including the integration of multiple links. When executed by processing circuitry 1004, D2D traffic module 1014 directs circuitry 1004 to select and implement configurations that exchange user data over D2D links as described herein—including the integration of multiple links.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a wireless communication system to implement a plurality of Device-To-Device (D2D) configurations, the method comprising:
wirelessly exchanging first control signaling between a base station system and a plurality of user communication devices over Base Station-To-Device (BS2D) signaling links, and in response, wirelessly exchanging first user data between the user communication devices and the base station system over BS2D traffic links;
wirelessly exchanging second control signaling between the base station system and the user communication devices over the BS2D signaling links, and in response, wirelessly exchanging second user data directly between the user communication devices over direct D2D traffic links;
selecting one of the D2D configurations based on communication system conditions wherein the plurality of D2D configurations have at least one of the user communication devices as hub user device(s) and have the other user communication devices as non-hub user devices; and
wirelessly transferring a D2D configuration instruction to the user communication devices over the BS2D signaling links, and in response, wirelessly exchanging third control signaling and third user data using the selected D2D configuration, wherein the selected D2D configuration comprises at least one of: a first D2D configuration where the non-hub user devices wirelessly transfer at least a portion of the third user data to one another through the hub user device(s), and a second D2D configuration where the non-hub user devices wirelessly transfer at least a portion of the third control signaling to the base station system through the hub user device(s).

2. The method of claim 1 wherein the first D2D configuration has the user communication devices inhibit wireless D2D communications with other user communication devices.

3. The method of claim 1 wherein the first D2D configuration has the non-hub user devices wirelessly transfer another portion of the third user data to the base station system through the hub user device(s).

4. The method of claim 1 wherein the first D2D configuration has the non-hub user devices wirelessly receive another portion of the third user data from the base station system through the hub user device(s).

5. The method of claim 1 wherein the first D2D configuration has the non-hub user devices wirelessly transfer the portion of the third control signaling to the base station system through the hub user device(s).

6. The method of claim 1 wherein the first D2D configuration has the non-hub user devices wirelessly receive another portion of the third control signaling from the base station system through the hub user device(s)

7. The method of claim 1 wherein the second D2D configuration has the non-hub user devices wirelessly transfer another portion of the third user data to the base station system through the hub user device(s).

8. The method of claim 1 wherein the second D2D configuration has the non-hub user devices wirelessly receive another portion of the third user data from the base station system through the hub user device(s).

9. The method of claim 1 wherein the second D2D configuration has the non-hub user devices wirelessly receive another portion of the third control signaling from the base station system through the hub user device(s).

10. The method of claim 1 wherein the portion of the third control signaling comprises a Physical Uplink Control Channel (PUCCH).

11. A wireless communication system to implement a plurality of Device-To-Device (D2D) configurations, the wireless communication system comprising:
a base station system; and
a plurality of user communication devices; wherein
the base station system and the user communication devices are configured to wirelessly exchange first control signaling over Base station system-To-Device (BS2D) signaling links, and in response, wirelessly exchange first user data between the user communication devices and the base station system over BS2D traffic links;
the base station system and the user communication devices are configured to wirelessly exchange second control signaling between the base station system and the user communication devices over the BS2D signaling links, and in response, wirelessly exchange second user data directly between the user communication devices over direct D2D traffic links;
the base station system is configured to select one of the D2D configurations based on communication system conditions and to wirelessly transfer a D2D configuration instruction to the user communication devices over the BS2D signaling links, wherein the plurality of D2D configurations have at least one of the user communication devices as hub user device(s) and have the other user communication devices as non-hub user devices;
the base station system and the user communication devices are configured to wirelessly exchange third control signaling and third user data using the selected D2D configuration in response to the D2D configuration instruction; and
the selected D2D configuration comprises at least one of: a first D2D configuration where the non-hub user devices wirelessly transfer at least a portion of the third user data to one another through the hub user device(s), and a second D2D configuration where the non-hub user devices wirelessly transfer at least a portion of the third control signaling to the base station system through the hub user device(s).

12. The wireless communication system of claim 11 wherein the first D2D configuration has the user communication devices inhibit wireless D2D communications with other user communication devices.

13. The wireless communication system of claim 11 wherein the first D2D configuration has the non-hub user devices wirelessly transfer another portion of the third user data to the base station system through the hub user device(s).

14. The wireless communication system of claim 11 wherein the first D2D configuration has the non-hub user devices wirelessly receive another portion of the third user data from the base station system through the hub user device(s).

15. The wireless communication system of claim 11 wherein the first D2D configuration has the non-hub user devices wirelessly transfer the portion of the third control signaling to the base station system through the hub user device(s).

16. The wireless communication system of claim 11 wherein the first D2D configuration has the non-hub user devices wirelessly receive another portion of the third control signaling from the base station system through the hub user device(s)

17. The wireless communication system of claim 11 wherein the second D2D configuration has the non-hub user devices wirelessly transfer another portion of the third user data to the base station system through the hub user device(s).

18. The wireless communication system of claim 11 wherein the second D2D configuration has the non-hub user devices wirelessly receive another portion of the third user data from the base station system through the hub user device(s).

19. The wireless communication system of claim 11 wherein the second D2D configuration has the non-hub user devices wirelessly receive another portion of the third control signaling from the base station system through the hub user device(s).

20. The wireless communication system of claim 11 wherein the portion of the third control signaling comprises a Physical Uplink Control Channel (PUCCH).
